(19) United States
(12) Patent Application Publication
(10) Pub. No.: US 2006/0259218 A1
(43) Pub. Date: Nov. 16, 2006

(54) Audio-video recorder for vehicles

(76) Inventors: Bing-Fei Wu, Hsinchu City (TW); Chao-Jung Chen, Taipei City (TW); Hsin-Yuan Peng, Taitung City (TW)

Correspondence Address: BUCKNAM AND ARCHER, 1077 NORTHERN BOULEVARD, ROSLYN, NY, 11576, US

(21) Appl. No.: 11/273,109

(22) Filed: Nov. 14, 2005

(30) Foreign Application Priority Data
May 10, 2005 (TW) 94114989

(51) Int. Cl. G06F 19/00

(52) U.S. Cl. 701/35

(57) ABSTRACT

The present invention relates to an audio-video recorder for vehicles, which is capable of judging whether the vehicles are at risk or emergent situation, then, if necessary, activating the audio-video recording of the driving process, and preserving the data after encryption. If there is any traffic accident happened and some accident causes need to be judged, the data preserved by the recorder can serve as an important basis.

### BACKGROUND OF THE INVENTION

1. Field of the Invention

The present invention relates to a recorder, in particular to a recorder suitable for simultaneously recording images and sounds for vehicles.

2. Discussion of Related Art

FDR, i.e. flight data recorder, a.k.a. “black box”, is only a voice recorder used in the pilot's compartment, which provides limited data yet the important clues to judge the causes of flight accidents. The recorder for transportation system on the ground is developed from the concept of the aforementioned FDR, which meets the imperious demands for improving the traffic safety and analysis of causes of accidents after economic development.

U.S. Pat. No. 3,983,565 and U.S. Pat. No. 5,639,967 have disclosed conventional recorders for recording the wheel information of vehicles, however both of which are recorders in early phases. Furthermore, Taiwanese Patent Publication No. 350, 536, entitled “Drive Recorder”, has disclosed a general conventional drive recorder, but the object of which mainly aims at the recording of the status of the vehicle itself, such as the states of the car doors, the brakes, the indicators, the headlights, and the motor speed, which cannot provide perceivable image and sound data for more accurate judgment.

European Patent No. EP 1, 492, 056, “Drive Recorder Comprising a Camera Photographing Images Inside and Outside of a Vehicle”, has disclosed a drive recorder that the trigger for the recording function must be an impact sensor being attached additionally, whereby the recording function of the recorder will not be initiated until the vehicle is impacted, and thus only the on-site situation thereupon and thereafter can be recorded but the situation where the emergency starts.

Besides, aforementioned recorder temporarily stores image data in reserved buffer space. If the recording period is not very long, the data can still be fully recorded; however, if the recording period is long enough to overbrim the recording capacity, the buffer memory may be insufficient whereby the data may fail to be fully recorded.

### SUMMARY OF THE INVENTION

The present invention is made due to the motivation which is in view of the aforementioned problems, more particularly the present invention is to provide a recorder for vehicles, which is capable of recording image and sound data during the movement of the vehicle. Especially when the vehicle meets an emergent or dangerous situation, the movement of the vehicle during occurrence of the accident, further prior to occurrence of the accident while defining an emergent or dangerous situation, can be rebuilt to help clarify the cause of the accident and the liability for compensation.

In order to achieve the above objects, the audio-video recorder for vehicles of the present invention comprises a micro-controller for judging if the vehicle gets into a dangerous situation and receiving an external emergency signal; at least an image capture device for receiving a capture-start signal and outputting image data; at least a sound capture device for receiving a capture-start signal and outputting sound data; a data processing core for processing the data outputted by the image capture device and the sound capture device, compressing and encrypting the data and outputting the encrypted data; and at least a storage medium for receiving and storing the data outputted by the data processing core.

The audio-video recorder for vehicles according to the present invention records image and sound data simultaneously and effectively stores the image and sound data by means of image and sound data compression; moreover, data encryption is utilized to exclusively grant those related the authority for reading the data.

According to recorder of the present invention, furthermore it will be much easier to clarify a cause of an accident by comparing these data with the states of the vehicle itself, e.g. the states of speed, brakes, indicators etc.

To sum up, the recorder according to the present invention can detect if a vehicle enters a dangerous situation and lasts a short period of time. Once the vehicle enters a dangerous situation, the related image and sound data will be immediately compressed, encrypted and stored. If there is any violation of traffic regulations or accident, the image and sound data can serve as a basis for judging the liability for the accident or an evidence of the violation of traffic regulations.

Another object of the present invention is that the recorder has the capability of wireless internet access, which can further combine with a burglarproof system to obstruct thieves.

### BRIEF DESCRIPTION OF THE DRAWINGS

FIG. 1 is a block diagram showing the configuration of the audio-video recorder for vehicles according to a preferred embodiment of the present invention;

FIG. 2 is a flowchart showing the operation of the audio-video recorder for vehicles according to a preferred embodiment of the present invention;

FIGS. 3a and 3b are schematic views showing the computing of a central lane line according to a preferred embodiment of the present invention;

FIGS. 4a and 4b are schematic views showing the computing of lane deviation value; according to a preferred embodiment of the present invention;

FIGS. 5a and 5b are schematic views showing the computing of distance from a vehicle ahead according to a preferred embodiment of the present invention; and

FIG. 6 is a schematic view showing the contrast between a position in an image and the real distance.

### DETAILED DESCRIPTION OF PREFERRED EMBODIMENTS

A preferred embodiment of the present invention will be described with reference to the accompanying drawings.

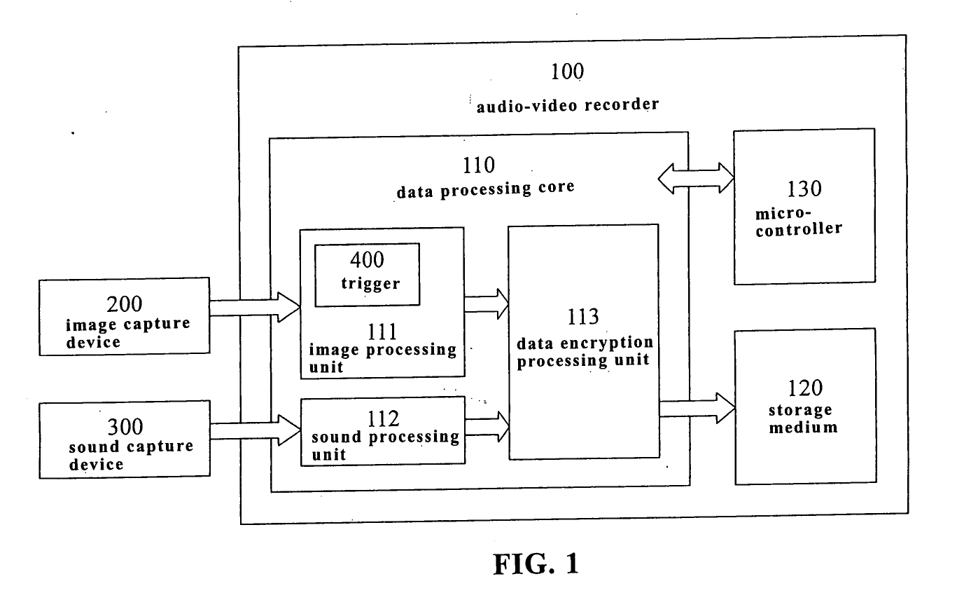

FIG. 1 is a block diagram showing the configuration of the audio-video recorder for vehicles according to the preferred embodiment.

Referring to FIG. 1, in the audio-video recorder 100, a micro-controller 130 is in charge of detecting the state of a vehicle or receiving a trigger 400. The audio-video recorder 100 will start if there is any abnormal situation. A data processing core 110 receives image and sound data from an image capture device 200, e.g. CCD camera, and a sound capture device 300, e.g. microphone. Through an image processing unit 111, a sound processing unit 112 and a data encryption processing unit 113, the image and sound data are processed and stored into a storage medium 120.

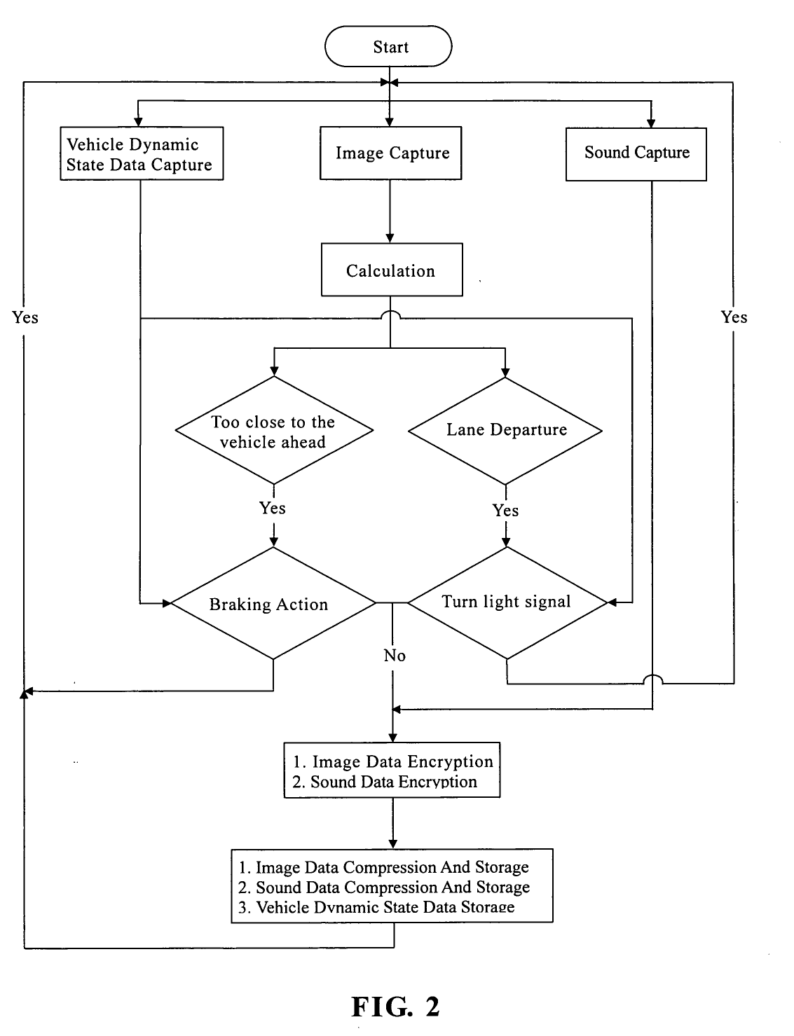

Referring to FIG. 2, it shows a flowchart of the operation of the audio-video recorder for vehicles according to a preferred embodiment of the present invention. By computerizing a real-time image caught by image capture device, a real-time sound caught by sound capture device and associating with vehicles dynamic state data capture, the system devices provide a function to judge if the vehicle is under a dangerous situation, e.g. some unreasonable status including lane departure and too close to the vehicle ahead. When a vehicle is judged as being in either one of the unreasonable status, the system device will release a warning signal until the unreasonable status is removed, i.e. signal of lane departure could be removed due to action of turning directions associated with interpretation of tendency to normal status by judging subsequent data of image and sound; furthermore, signal of too close to the vehicle ahead could be removed due to action of riding the brake associated with interpretation of tendency to normal distance from device to the vehicle ahead by judging subsequent data of image and sound.

When the dangerous situation for the vehicle is remaining for a short period of time or getting worse, the system devices shall initiate the recording functions which includes image data compression and storage, sound data compression and storage, and vehicle dynamic data storage, wherein the vehicle dynamic data storage is a remaining function of the conventional audio-video recorder for vehicles, which records the states of indicators, brakes, accelerator, car speed, and steering wheels etc.

If an accident occurs, the on-site situation before or during the occurrence of the accident can be rebuilt to the utmost by these recorded data to help clarify the cause of the accident and the liability for compensation.

Several means to determine if a vehicle is under a dangerous situation according to the present invention will be recited hereinafter.

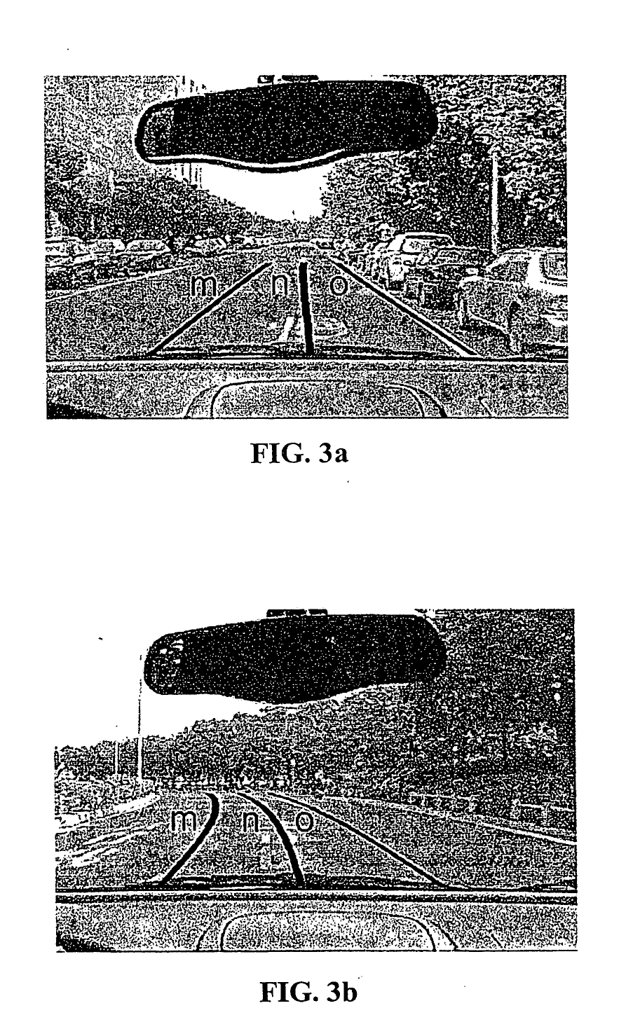

Referring to FIGS. 3a and 3b, the system can immediately detect the information about lane lines m and o through the captured images and derive the central lane line n thereby. Meanwhile, the information such as the coordinate positions of m and o and the lane line curvature are also computed together.

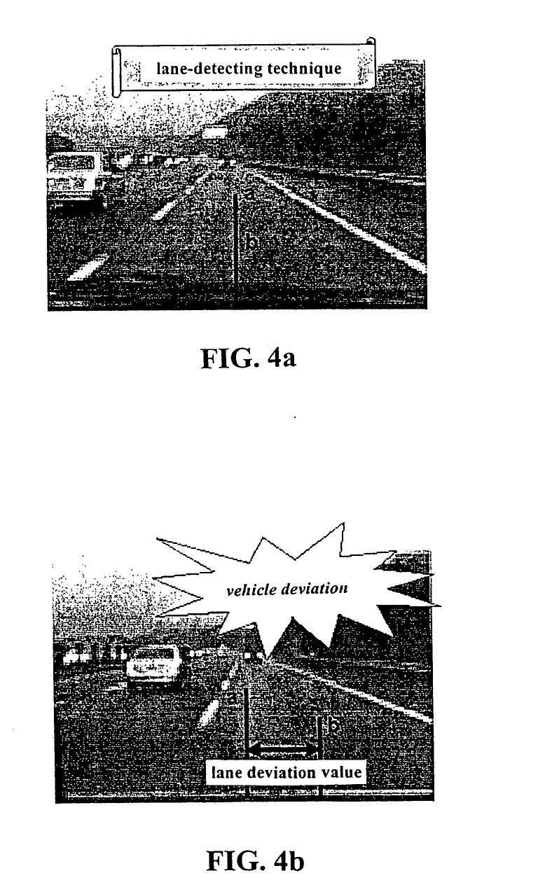

Further referring to the FIGS. 4a and 4b, line a is the central position of the vehicle, and line b is the central lane line derived by the above computing. Therefore the difference between lines a and b is defined as lane deviation value. The system device can compute the deviation value together with other detected information, e.g. lane curvature and states of indicators, to judge if the vehicle deviates from the lane improperly thereby. For example, if the vehicle deviates from the lane without flashing indicators, the system will judge that the vehicle is under an abnormal situation and initiate the image and sound recording function.

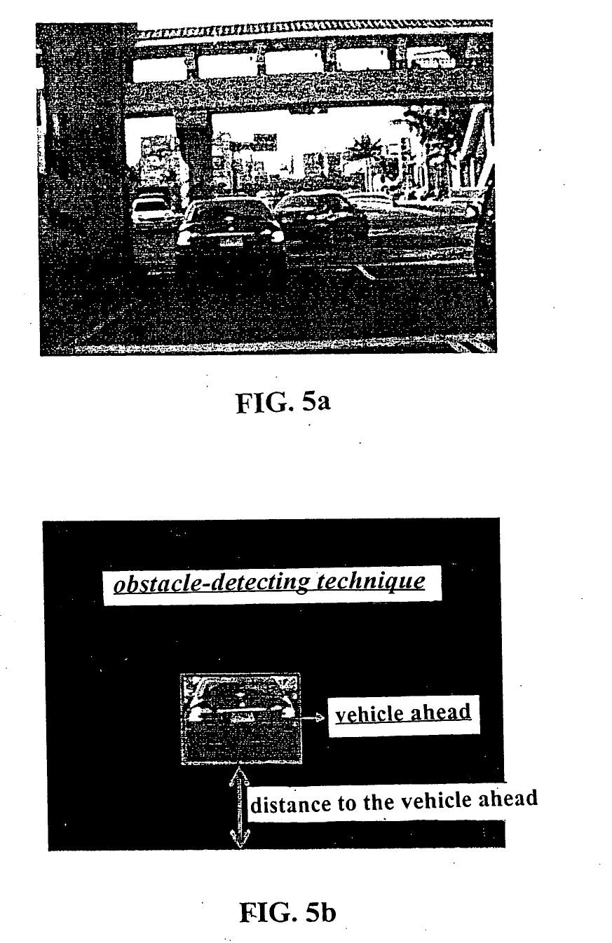

Referring to FIGS. 5a and 5b, the system can immediately recognize the obstacle ahead by the captured image and derive the relation between the position in the image and the real distance by computing the pixels in the image with a 3D-to-2D mathematical model.

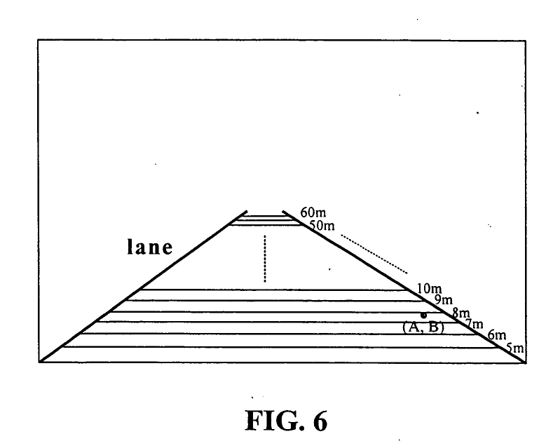

Referring to FIG. 6, the system can predetermine the relation between the coordinate position (A, B) in the image and the real distance, whereby deriving the distance between the vehicle and the obstacle; cooperating the derived distance with the state information of the brakes and speed, the system can determine if the vehicle enters a dangerous situation and initiate recording function thereby. For example, if the vehicle is approaching a vehicle ahead at a high speed without applying brakes and the speed does not slow down, the system will judge that the vehicle is under a dangerous situation.

In addition, the present invention can be combined with other mobile internet modules such as GPRS, 3G etc, together with additional cameras to recording the condition inside a vehicle, and via system calculation, it can be judged if the vehicle is invaded. If the vehicle is judged as being invaded, compression of image and sound data can also be carried out and the image and sound data will immediately be transmitted to the car owner's mobile device such as mobile phone, PDA, and E-mail box, FTP etc via wireless internet.

Though the present invention is described with respect to the particular embodiment, it will be apparent to those skilled in the art that various changes and modification may be made without departing from the spirit and scope of the invention as defined in the following claims.

What is claimed is:

1. An audio-video recorder for vehicles, comprising:
a micro-controller for judging whether a vehicle enters a dangerous situation and receiving an external emergency signal;
at least an image capture device for receiving a capture-start signal and outputting image data;
at least a sound capture device for receiving a capture-start signal and outputting sound data;
a data processing core for processing the data outputted by the image capture device and the sound capture device, compressing and encrypting the data and outputting the encrypted data; and
at least a storage medium for receiving and storing the data outputted by the data processing core,
wherein the audio-video recorder is initiated when the micro-controller judges that the vehicle enters a dangerous situation and lasts a short period of time, and the data processing core starts receiving image and sound data from the image capture device and the sound capture device; after being processed by the data processing core, the image and sound data are stored in the storage medium.

2. The audio-video recorder according to claim 1, wherein the micro-controller not only receives the external emergency signal but also judges a current emergent situation by means of its internal calculation to determine whether the audio-video recorder should be on.

3. The audio-video recorder according to claim 1, wherein the image capture device includes image-sensing modules such as CCD and CMOS.

4. The audio-video recorder according to claim 1, wherein the data processing core comprises an image processing unit, a sound processing unit, and a data encryption unit.

5. The audio-video recorder according to claim 4, wherein the image processing unit executes image processing and image compression by means of hardware and software.

6. The audio-video recorder according to claim 5, wherein the hardware is IC or FPGA.

7. The audio-video recorder according to claim 4, wherein the sound processing unit executes sound processing and sound compression by means of hardware and software.

8. The audio-video recorder according to claim 7, wherein the hardware is IC or FPGA.

9. The audio-video recorder according to claim 4, wherein the data encryption unit executes data encryption by means of hardware and software.

10. The audio-video recorder according to claim 1, wherein the storage medium is a conventional storage medium such as HD, flash memory, or CD storage module.
